(19) United States
(12) Patent Application Publication
(10) Pub. No.: US 2006/0048904 A1
(43) Pub. Date: Mar. 9, 2006

(54) Dual drop covering for architectural openings

(75) Inventor: Christopher P. Gruner, Frederick, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Hunter Douglas Inc., Upper Saddle River, NJ (US)

(21) Appl. No.: 11/217,800

(22) Filed: Sep. 1, 2005

Related U.S. Application Data
(60) Provisional application No. 60/608,284, filed on Sep. 8, 2004.

(51) Int. Cl. A47H 5/00; E06B 3/48

(52) U.S. Cl. 160/84.05

(57) ABSTRACT

A covering for an architectural opening has a vertically retractable panel composed of a plurality of vertically stacked component parts and a control system for independently operating each component part to extend or retract that component part independently or in combination with all the component parts. A control system for the covering includes independent system components associated with each component part of the panel.

### CROSS-REFERENCE TO RELATED APPLICATION

This application claims the benefit of U.S. provisional application No. 60/608,284 filed Sep. 8, 2004, which application is hereby incorporated by reference as if fully disclosed herein.

### BACKGROUND OF THE INVENTION

1. Field of the Invention

The present invention relates generally to retractable coverings for architectural openings such as windows, doors, archways, and the like, and more particularly to a retractable covering having a covering panel with distinct and physically different component parts which are independently operable by a control system disposed in a headrail for the covering.

2. Description of the Relevant Art

Coverings for architectural openings such as windows, doors, archways, and the like have assumed numerous forms for many years. Initially, such coverings consisted primarily of fabric draped across all or a portion of the architectural opening while more recent coverings have been of a retractable nature. In retractable coverings, the covering is typically retractable to a position adjacent one edge of the architectural opening while being capable of being extended across the opening with an appropriate control system.

Venetian blinds are a popular form of retractable covering for architectural openings and include a plurality of horizontally disposed slats which can be tilted about their longitudinal horizontal axes to move the covering between open and closed positions. The slats can also be gathered adjacent one edge of the opening in a retracted position or extended across the opening in evenly spaced distribution in an extended position of the covering.

Vertical blinds are also a popular form of retractable covering for architectural openings with such coverings resembling venetian blinds but wherein the slats are suspended vertically rather than horizontally. The operation of the covering is similar in that the slats can be rotated about their longitudinal axes, which in this instance extend vertically, can be gathered adjacent to one or both sides of the opening in a retracted condition or distributed across the opening in an extended position with the slats evenly distributed.

More recently, cellular shades have become popular with such shades in some instances including a plurality of vertically stacked, horizontally disposed collapsible cells which can be extended across the opening in an extended position of the covering or retracted adjacent the top or bottom of the opening by transversely collapsing the cells into a neat stack.

Another form of cellular covering includes a pair of spaced flexible sheets of material, which are typically sheer, and a plurality of horizontally disposed vanes or slats which interconnect the two sheets of material at evenly spaced locations so that vertical movement of the flexible sheets of material in opposite directions causes the vanes to pivot about longitudinal axes thereof between open and closed positions. The entire covering can be retracted onto a roller adjacent one edge of the opening or extended across the opening with the vanes in either an open or closed position.

Another popular retractable shade consists of a pleated sheet of rigid or semi-rigid material defining adjacent segments which are hingedly connected along fold lines so that adjacent segments extend in opposite directions when the shade is extended and can be retracted adjacent one side of the architectural opening in a compact stack in a retracted position.

Retractable coverings also exhibit different visual and light-conducting characteristics with some coverings being made of opaque materials so that when extended across the architectural opening, they block light and vision through the opening. Others selectively allow the passage of light or vision therethrough when in an extended position by for example rotating slats or vanes between open and closed positions. It has also been desired and provided in coverings for architectural openings that one face of the covering has a different aesthetic than the opposite face such as being made of a different material or of a different color or having different light-transmitting capabilities giving variety and alternatives to consumers of such architectural covering products.

It is to provide further alternatives to consumers of architectural covering products that the present invention has been developed.

### BRIEF SUMMARY OF THE INVENTION

The present invention relates to a retractable covering for architectural openings wherein a panel for the covering is comprised of independently operable component parts. The component parts can be manipulated to extend across the architectural opening in aggregate or can individually extend across the architectural opening so as to give alternatives to the characteristics of the panel from an aesthetic as well as functional standpoint.

Each component part of the panel is made of a structure or aesthetic that is distinct from the other component parts such as cellular/non-cellular, transparent/opaque, or one color/another color. Many variations in the components of the panel are permissible so long as each component part is of a retractable nature.

While the covering could be disposed for retraction in a horizontal direction, the preferred embodiment is vertically retractable and includes a headrail in which a control system is placed. The control system is designed to move the panel between extended and retracted positions and to also independently operate each component part of the panel to obtain various dispositions of the component parts of the panel relative to the architectural opening.

The control system itself consists of independently operable system components to effect the various optional deployments of the covering. Each component is operated with a unidirectional drive cord depending as a single cord from the headrail.

Other aspects, features, and details of the present invention can be more completely understood by reference to the following detailed description of a preferred embodiment taken in conjunction with the drawings and from the appended claims.

### BRIEF DESCRIPTION OF THE DRAWINGS

FIG. 1 is an isometric view of a covering in accordance with the present invention in a fully retracted position.

FIG. 2 is a section taken along line 2-2 of FIG. 1.

FIG. 3 is an enlarged section taken along line 3-3 of FIG. 2.

FIG. 4 is an enlarged section taken along line 4-4 of FIG. 2.

FIG. 4A is a further enlarged fragmentary section showing the interconnection of the lower shade component with the bottom rail of the covering.

FIG. 5 is an isometric of the covering of FIG. 1 showing the lower panel component extended and the upper panel component retracted.

FIG. 6 is an isometric of the covering of the present invention with both the upper and lower panel components in a partially extended position.

FIG. 7 is an isometric of the covering of the present invention with the upper panel component extended and the lower component retracted.

FIG. 8 is an end elevation of the bottom rail used in the covering of the present invention which in an inverted orientation serves as a midrail for the covering.

FIG. 9 is an enlarged isometric looking downwardly on the top of the rail of FIG. 8.

FIG. 10 is an enlarged isometric looking upwardly at the bottom of the rail of FIG. 8.

FIG. 11 is an end elevation of the headrail for the covering of the present invention.

FIG. 12 is an enlarged isometric of the headrail of FIG. 11 looking downwardly on the top of the headrail.

FIG. 13 is an end elevation of an end cap for the headrail of FIG. 11.

FIG. 14 is an isometric of the end cap shown in FIG. 13.

FIG. 15 is an end elevation of an end cap for the rail of FIG. 8.

FIG. 16 is an isometric of the end cap shown in FIG. 15.

FIG. 17 is an end elevation of a retention strip used in the rail of FIG. 8.

FIG. 18 is an isometric looking downwardly on the retention strip of FIG. 17.

FIG. 19 is an isometric of an operating system component used to operate one component part of the panel of the covering of the present invention.

### DETAILED DESCRIPTION OF THE INVENTION

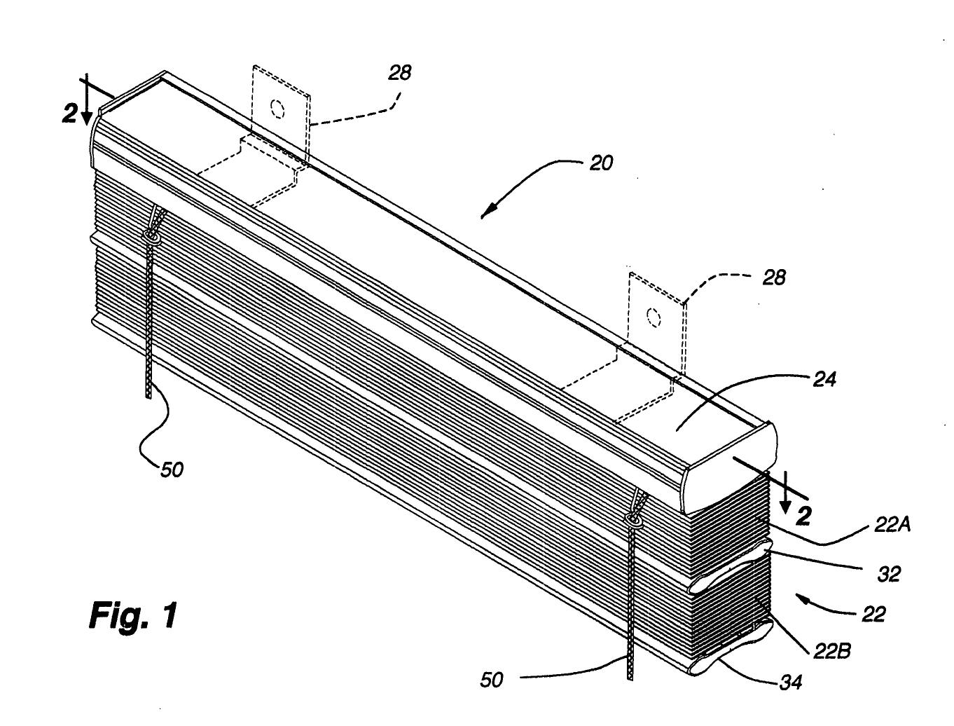

As best seen in FIGS. 1, 5, 6, and 7, the covering 20 of the present invention includes a retractable panel 22 composed of upper 22A and lower 22B component parts with the panel being suspended from a headrail 24 in which a control system 26 is confined for movement of the panel between extended and retracted positions. While the panel 22 will be described hereinafter as a vertically retractable panel, it will be appreciated by those skilled in the art that the principles of the invention can also be applied to a horizontally retractable panel.

The covering 20 is shown in a retracted position in FIGS. 1, 3 and 4, and it will also be appreciated in FIG. 1 that mounting brackets 28 are shown in dashed lines which can be used for connecting the headrail 24 for the covering to the framework of an architectural opening which in the disclosed embodiment of the invention would be along a top frame member of the architectural opening which is not shown. The retractable panel 22 in the disclosed embodiment of the present invention, as is probably best appreciated by reference to FIG. 6, includes the upper 22A and lower 22B component parts each of which are transversely collapsible cellular shades made from horizontally extending tubes or cells 30 of a flexible material that can be creased and folded into the desired tubular configuration of a cell. The cells are vertically stacked and longitudinally interconnected as with adhesive, ultrasonic welding, or the like to complete the component parts 22A and 22B of the panel. Such collapsible cellular panels are well known in the art. By way of example, such a cellular panel is described in detail in U.S. Pat. No. 4,631,217 issued Dec. 23, 1986, which is hereby incorporated by reference and is commonly owned with the present application. Such collapsible cellular shades can be made of many alternative materials such as, for example, sheer fabrics, opaque fabrics, translucent fabrics, various colors of materials, and even various cross-sectional shapes of cells that in aggregate compose a panel. In the present described embodiment, the cells in the upper component part 22A of the panel are made from a substantially transparent sheer material while the cells in the lower component part 22B of the panel are made from an opaque material. The upper and lower panels are interconnected with a midrail 32 which will be described in more detail hereafter while the lower edge of the lower component part 22B of the panel has a bottom rail 34 affixed thereto.

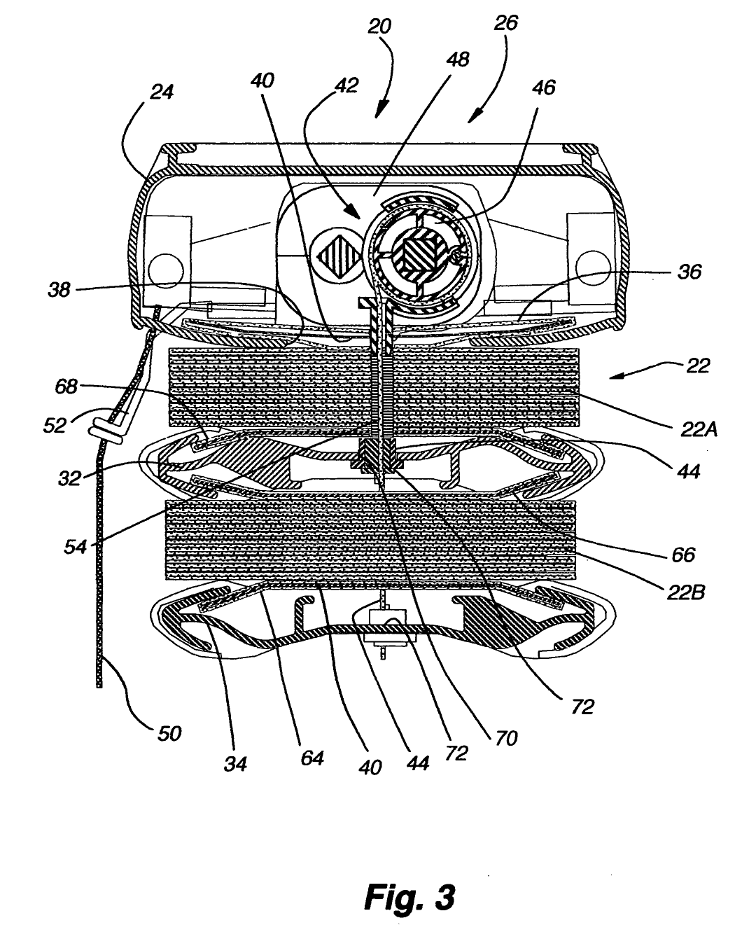

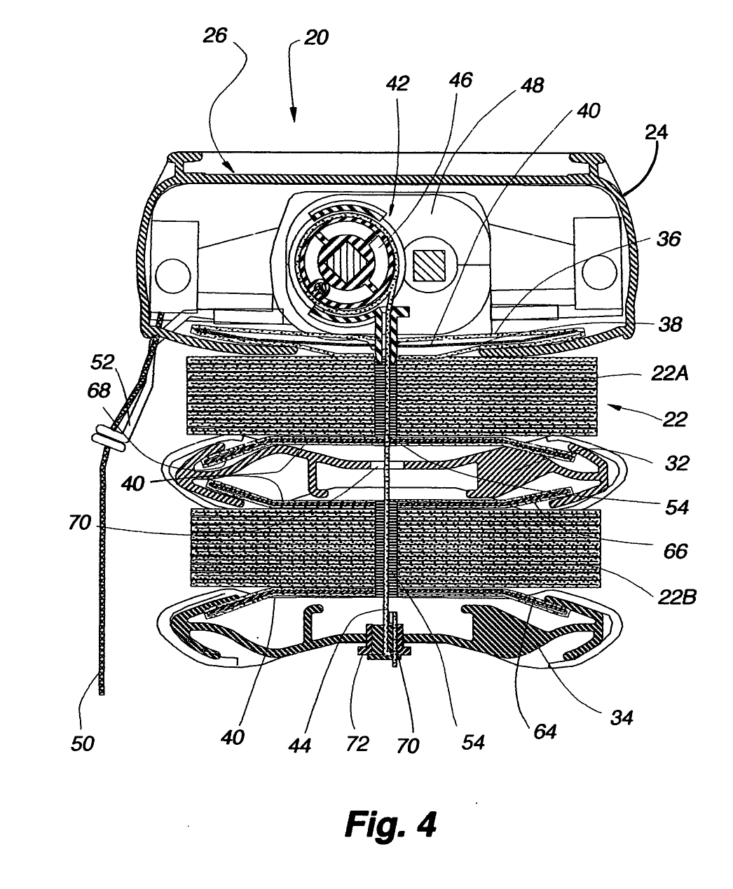

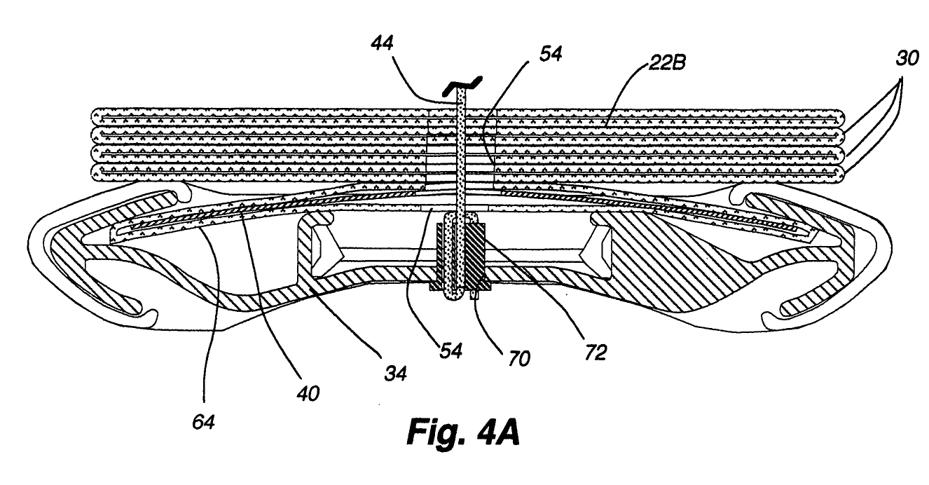

As probably best appreciated by reference to FIGS. 3 and 4, the uppermost cell 36 in the upper component part 22A of the panel is secured within the headrail 24 and protrudes through a longitudinally extending slot 38 in a bottom wall of the headrail. A retention strip 40 holds the uppermost cell in the headrail by being inserted longitudinally into the cell and into the headrail so that the panel 22 depends from the headrail through the longitudinal slot.

The operation of the covering 20, which will be described in more detail later, permits the upper 22A and lower 22B component parts of the panel to be manipulated independently or in unison. The control system 26 includes independent system components 42 each of which are associated with a component part 22A or 22B of the panel. The panel can be manipulated so that the upper component part is fully extended while the lower component part remains retracted (FIG. 7), the lower component part can be fully extended while the upper component part remains retracted (FIG. 5), the upper and lower component parts can be partially extended at the same time (FIG. 6) or the entire panel 22 can be fully retracted so that each component part is compactly stacked adjacent to the headrail 24 in a retracted position of the covering (FIGS. 1, 3 and 4).

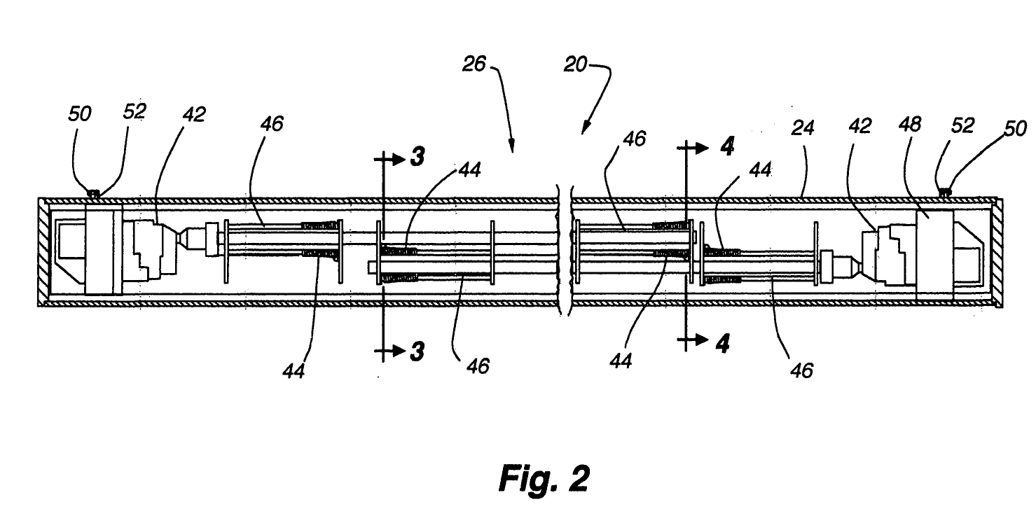

The control system 26 is mounted within the headrail 24 and as mentioned previously includes a system component 42, seen in FIGS. 2 and 19, associated with each component part 22A and 22B of the panel. The system components may be identical and of the type described in detail in U.S. Pat. No. 6,129,131 issued Oct. 10, 2000, which is of common ownership with the present application and is hereby incorporated by reference. Each system component 42 has a plurality of lift cords 44 associated therewith (two illustrated), which extend downwardly from the headrail through at least a portion of the collapsible panel 20 and are anchored to either the midrail 32 or the bottom rail 34. The lift cords can be pulled upwardly during a retracting operation of the control system to sequentially collapse the cells 30 in the panel above a raised rail 32 or 34 into a retracted stack. The lift cords are selectively raised and lowered by rotation of a spool 46 (FIGS. 2 and 19) in a system component 42 which is rotated in one direction by a clutch/brake assembly 48 through manipulation of a pull cord 50 and rotated in the opposite direction as a result of gravity acting on an associated rail 32 or 34 as described in detail in the '131 patent.

The pull cords 50 associated with each system component are seen best in FIGS. 1, 3, and 4 hanging downwardly from the front of the headrail 24 at opposite ends thereof. The clutch/brake assembly 48 is driven in one direction by a downward pulling motion on the pull cord and after a full stroke the pull cord retracts upwardly without driving the clutch/brake assembly. Repetitive downward pulling motions on the pull cord drive the clutch/brake assembly in one direction until the component panel part 22A or 22B associated therewith is fully retracted. A brake release lever 52 is provided in operative engagement with each pull cord so that lateral movement of the pull cord against the brake release lever releases a brake mechanism (not seen) that allows the associated panel component part to drop by gravity acting on its associated midrail or bottom rail into a fully extended position. Extension of the panel component part can be arrested by re-engaging the brake mechanism at any partially extended position of the panel component part by moving the brake release lever in the opposite direction.

The lift cords 44 associated with each system component 22A and 22B extend downwardly from an associated spool 46 about which it is adapted to be wrapped and passes through aligned openings 54 in each cell of one or both component parts 22A and 22B of the panel. The lift cords associated with the upper component part 22A of the panel are anchored at their lower end to the midrail 32 while the lift cords associated with the lower component part 22B extend downwardly through aligned openings 54 in both component parts of the panel before being anchored at their lower end to the bottom rail 34.

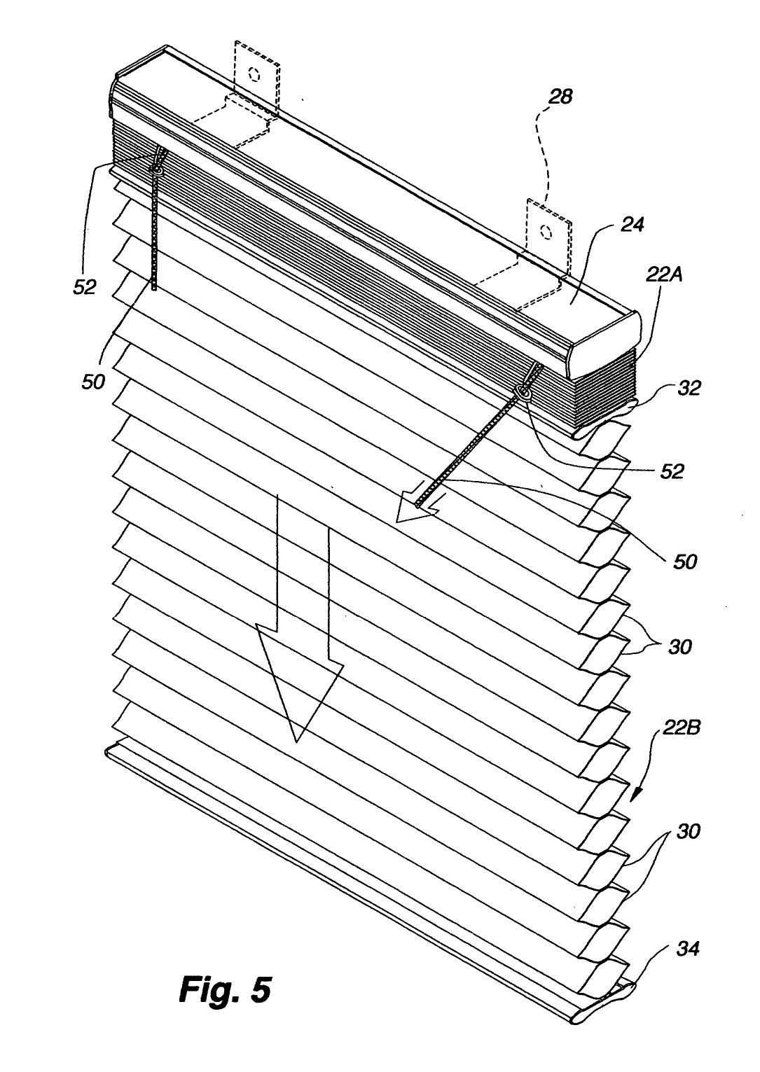

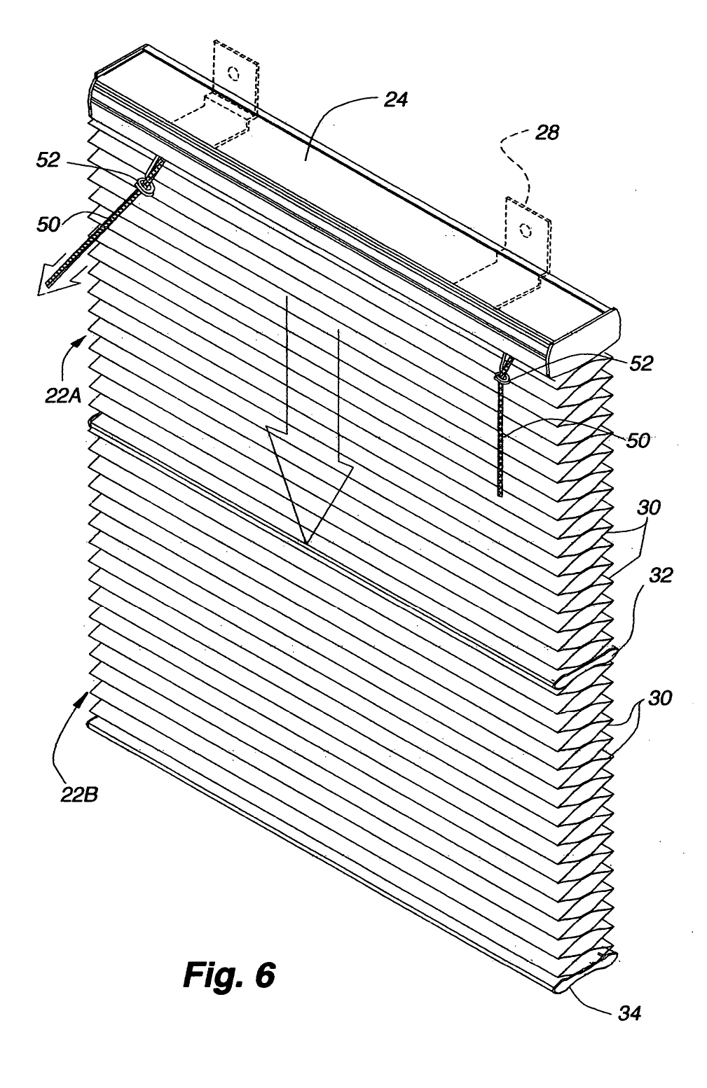

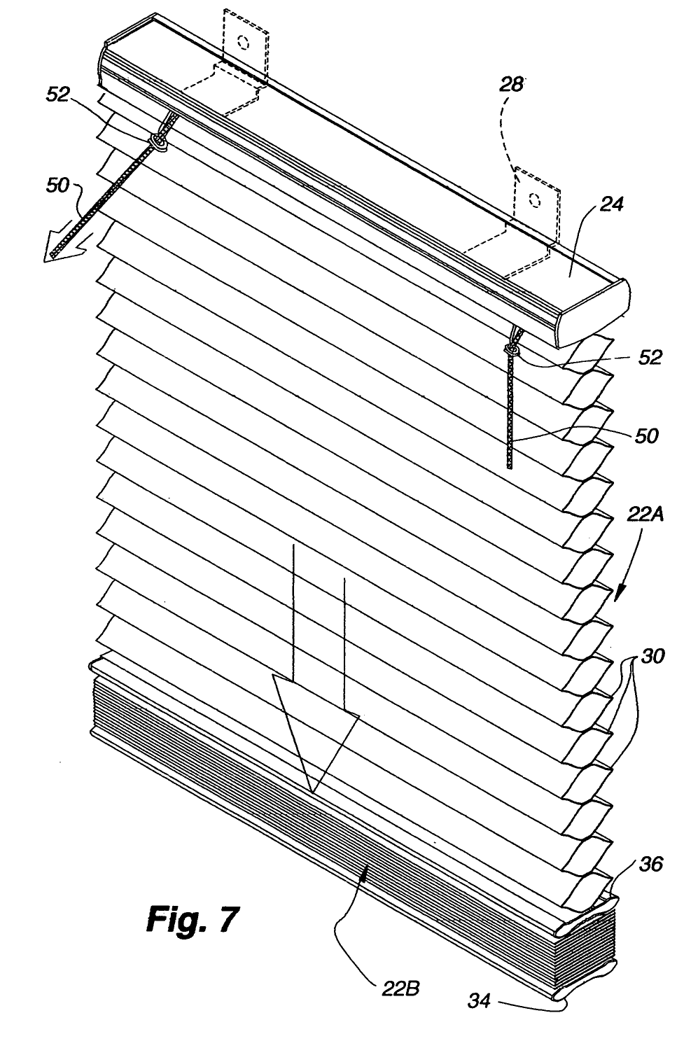

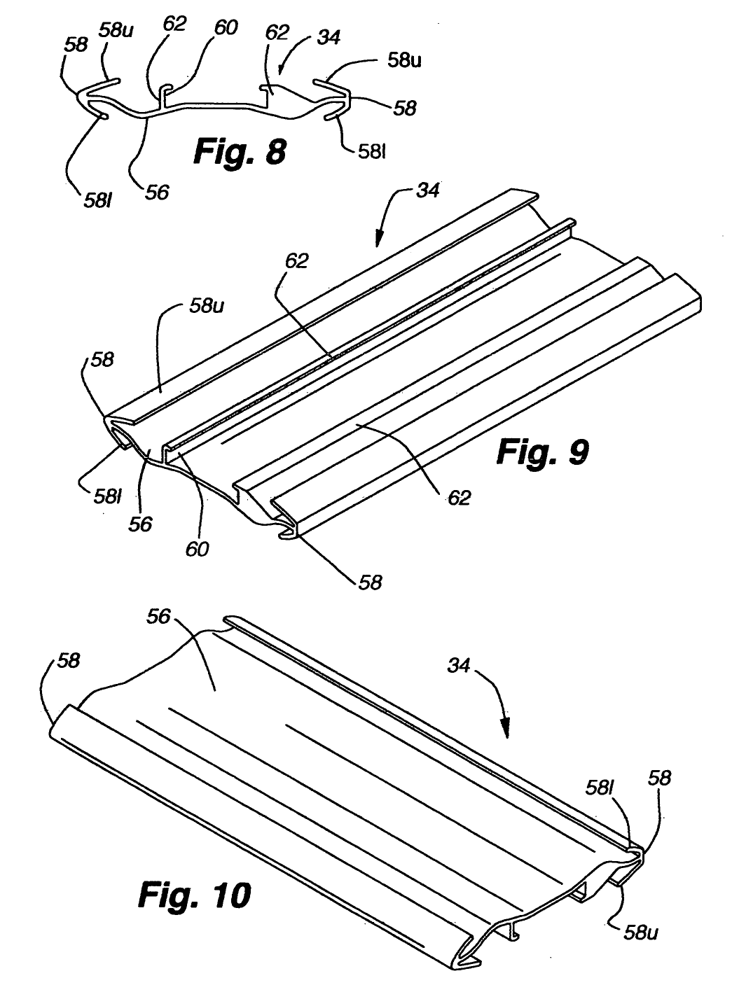

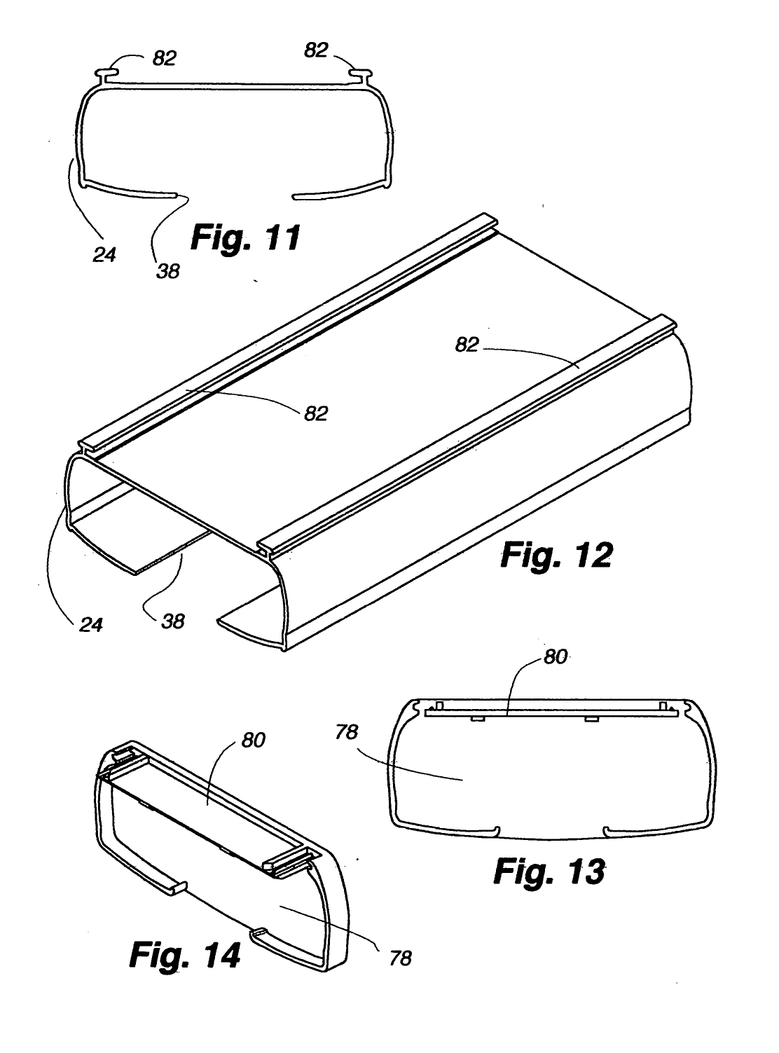

The bottom rail 34 and midrail 32 are of identical construction but are inverted in orientation. The rail is shown in FIGS. 8-10 as oriented for the bottom rail and will be seen to include a generally horizontally extending main body 56 with V-shaped flanges 58 along opposite longitudinal edges. The V-shaped flanges open toward each other and toward the center of the rail where a center channel 60 is defined by a pair of spaced upstanding ribs 62. As will be appreciated, each V-shaped flange defines an upper lip 58U above the main body and a lower lip 58L below the main body. The upper lips of each V-shaped flange are adapted to cooperate with a retention strip 40 as seen in FIGS. 17 and 18 which is a rigid or semi-rigid strip of material such as plastic adapted to be inserted into an adjacent cell 30 of a component part 22A or 22B of the panel associated with the rail. In other words, as probably best seen in FIGS. 3 and 4, the bottom rail 34, which is oriented as shown in FIGS. 8-10, has a portion of the lowermost cell 64 of the lower component part 22B of the panel inserted into the space between the upper lips 58U of the V-shaped flanges along opposite edges of the bottom rail. A retention strip 40 is inserted into the lowermost cell 64 with the retention strip being of a size to be confined beneath the upper lips. In this manner, the bottom rail is suspended from the lowermost cell 64 of the lower component part of the panel.

The rail illustrated in FIGS. 8-10, as mentioned previously, is inverted for use as the midrail 32 which is positioned between the upper 22A and lower 22B component parts of the panel as probably best seen in FIGS. 3 and 4. The midrail is secured to the upper and lower component parts of the panel in the same manner as the bottom rail 34 where it will be appreciated the uppermost cell 66 of the lower panel component part 22B is inserted into the space between the lower lips 58L of the midrail and retained therein by inserting a retention strip 40 into the uppermost cell 66 of the lower panel component part. Similarly, the lowermost cell 68 of the upper panel component part 22A is inserted into the space between the upper lips 58U of the midrail and is retained therein by a retention strip 40 inserted into the lowermost cell 68.

It will therefore be appreciated that through use of the midrail 32 and bottom rail 34 and the retention strips 40 in the midrail, bottom rail, and headrail 24, the entire panel 22 for the covering is dependably and desirably suspended from the headrail. The midrail is provided with openings 70 (FIGS. 3 and 4) not shown in FIGS. 8-10 which are punched in the main body of the rail at locations aligned with the lift cords 44 associated with each system component 42 of the control system 26. The lift cords associated with the upper component part 22A of the panel are anchored to the main body of the midrail with anchor plugs 72 as seen in FIG. 3 which are removably fixed in the openings 70 in the body of the midrail associated with the lift cords for the upper panel component part. The lift cords 44 associated with the lower panel component part 22B slidably pass through openings 70 provided in the midrail and subsequently through the aligned openings 54 in the cells 30 of the lower panel component part and are anchored with anchor plugs 72 to the main body of the bottom rail 34 in openings 70 (FIGS. 3 and 4) that are provided in the bottom rail but not shown in FIGS. 8-10.

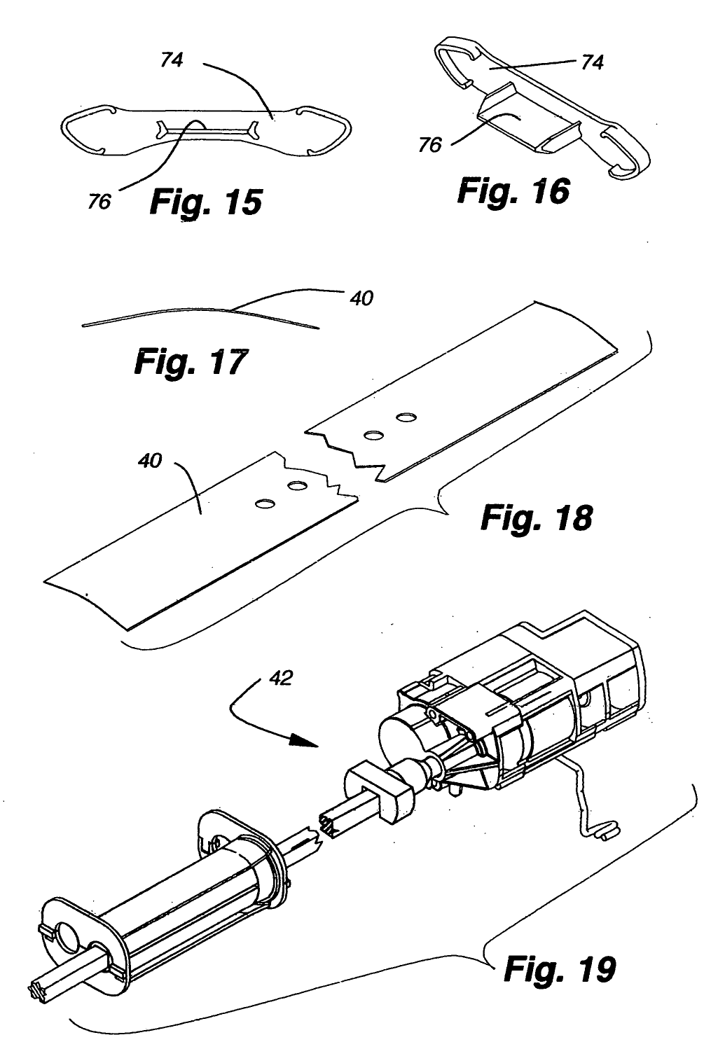

It will therefore be appreciated that movement of the lift cords 44 associated with one system component 42 will move the bottom rail 34 associated with the lower panel component part 22B up and down, and similarly the lift cords associated with the other system component 42 will move the midrail 32 up and down. For aesthetic purposes, the midrail and bottom rail are provided with end caps 74 shown in FIGS. 15 and 16 which have a profile corresponding to the transverse cross-sectional configuration of the rails 32 and 34 and have a protruding flange 76 adapted to be inserted and frictionally retained within the center channel 60 defined between the ribs 62 of the rails.

Similarly, the headrail 24 has end caps 78 shown in FIGS. 13 and 14 having a flange 80 adapted to be inserted and frictionally retained within a channel defined on the top of the headrail between inwardly opening channel-shaped protrusions 82 so that the end caps 78 give an aesthetically attractive closure to the opposite ends of the headrail while leaving the longitudinally extending slot 38 in the bottom wall of the headrail desirably exposed.

The system components 42 of the control system 26 are mounted within the headrail 24 at opposite ends of the headrail and in a reverse orientation even though the system components themselves are identical. The mounting of the system components in the headrail is probably best seen in FIG. 2 with the system components being mounted so that the pull cords 50 associated with the system components protrude outwardly from the front of the headrail adjacent opposite ends thereof. As mentioned previously, each system component is shown having two lift cords 44 associated therewith, with the lift cords of one system component being associated with the upper panel component part 22A and the lift cords associated with the other system component 22B being associated with the lower panel component part. The lift cords associated with each system component are operated simultaneously through manipulation of the pull cord 50 as described previously.

The operation of the covering 20 is probably best illustrated in FIGS. 1, 5, 6 and 7. In FIG. 1, both the upper 22A and lower 22B component parts of the panel are shown in a fully retracted position adjacent to the bottom of the headrail 24. With reference to FIG. 5, by releasing the brake mechanism associated with the system component 42 on the right side of the headrail by movement of the pull cord 50 to the left, allows the lift cords 44 to unroll from their associated spools 46 due to gravity acting on the weight of the bottom rail 34 which extends the lower panel component part while the upper panel component part remains retracted adjacent to the bottom of the headrail. If the brake mechanism associated with the left system component 42 is thereafter released by lateral movement of its associated pull cord 50 as shown in FIG. 7, the midrail 32 is allowed to drop by gravity thereby extending the upper panel component part 22A while the lower panel component part 22B is automatically forced to collapse or retract at the bottom of the panel. If the pull cord associated with the left system component is then pulled downwardly lifting the midrail 32, the lower panel component part 22B begins to expand upwardly while the upper panel component 22A begins to collapse. The midrail can be releasably locked in any intermediate position by using the brake mechanism associated with the left system component. In other words, the panel 22 could be disposed as shown in FIG. 6 with both the upper and lower panel component parts partially extended. The overall length of the panel 22 in the fully extended condition, however, remains of a predetermined size to cover the architectural opening in which the covering is mounted even though either component part 22A or 22B of the panel can be partially extended alone or together. The extent to which the overall panel 22 is extended is determined by the positioning of the bottom rail 34.

To completely retract the panel 22, the pull cord 50 associated with the lower panel component part 22B at the right end of the headrail is pulled downwardly in a reciprocating manner until the bottom rail 34 is fully lifted adjacent to the headrail as shown in FIG. 1, which causes both panel component parts to collapse or become retracted adjacent to the headrail.

It will be appreciated from the above that individual manipulation of the system components 42 associated with the upper and lower panel component parts 22A and 22B can dispose or position the panel 22 in a variety of different positions. Further, if the upper and lower panel component parts are made of different materials such as transparent and opaque materials, respectively, then the passage of light and vision through the extended or partially extended panel can be varied as desired. Further, one component part 22A or 22B of the panel might be made of one color while the other component part is made of another color to vary the color scheme associated with the covering. As will also be appreciated, various panel structures can be utilized on the top or bottom which are structurally the same or different. For example, pleated, planar or cellular products could be used for the upper and lower panel component parts with both parts being structurally the same or different. Also, more than two panel component parts could be used in the panel by vertically superimposing the additional component parts and adding additional control system components 42 in the headrail 24 with additional midrails 32 separating the various component parts of the panel.

Although the present invention has been described with a certain degree of particularity, it is understood the disclosure has been made by way of example, and changes in detail or structure may be made without departing from the spirit of the invention as defined in the appended claims.

What is claimed is:

1. A covering for an architectural opening comprising in combination:
a panel mounted in said opening for movement between extended and retracted positions relative to said opening, said panel having at least two component parts, and
a control system for selectively extending individual component parts independently of the other component parts.

2. The covering of claim 1 wherein said control system simultaneously extends one component part of said panel while retracting another component part.

3. The covering of claim 1 or 2 wherein said control system simultaneously retracts all component parts.

4. The covering of claim 1 or 2 wherein said control system selectively retracts one component part independently of the other component parts.

5. The covering of claim 3 wherein said control system selectively retracts one component part independently of the other component parts.

6. The covering of claim 1 wherein said panel includes a midrail between each component part.

7. The covering of claim 6 wherein each midrail is operatively connected to said control system.

8. The covering of claim 1 further including a headrail from which said panel is suspended and in which said control system is mounted.

9. The covering of claim 8 wherein said component parts have different physical characteristics.

10. The covering of claim 9 wherein said component parts are of cellular construction.

11. The covering of claim 8 wherein said control system simultaneously extends one component part of said panel while retracting another component part.

12. The covering of claim 11 wherein said control system simultaneously retracts all component parts.

13. The covering of claim 8 wherein said control system selectively retracts one component part independently of the other component parts.

14. The covering of claim 12 wherein said control system selectively retracts one component part independently of the other component parts.

15. The covering of claim 8 wherein said panel includes a midrail between each component part.

16. The covering of claim 15 wherein each midrail is operatively connected to said control system.

17. The covering of claim 8 wherein said control system includes a plurality of identically operable system components, each system component being individually operable and operably associated with a distinct panel component part.
